(19) United States
(12) Patent Application Publication
(10) Pub. No.: US 2009/0307532 A1
(43) Pub. Date: Dec. 10, 2009

(54) STEALTHY DEBUGGER

(76) Inventor: Jason Neal Raber, Bellbrook, OH (US)

Correspondence Address: KEITH D. NOWAK, CARTER LEDYARD & MILBURN LLP, 2 WALL STREET, NEW YORK, NY, 10005, US

(21) Appl. No.: 12/477,858

(22) Filed: Jun. 3, 2009

Related U.S. Application Data
(60) Provisional application No. 61/058,588, filed on Jun. 4, 2008.

(51) Int. Cl. G06F 11/36

(52) U.S. Cl. 714/38; 714/E11.208

(57) ABSTRACT

A method of stealthily debugging software comprises dynamically injecting a jump into an executing target program; performing a debugging operation on the target program; and dynamically removing the injected jump from the target program. Dynamically injecting a jump comprises copying memory contents from a selected breakpoint location to a second memory location, and writing a jump instruction and location at the breakpoint location. Dynamically removing the injected jump comprises copying memory contents back to the breakpoint location from the second memory location. The method may further comprise replacing a pointer to a system function with a pointer to a debug module in a syscall table, and placing the debug module in a slack space of the target program. A debugging system is also disclosed.

### RELATED APPLICATIONS

This application claims priority from U.S. Provisional Application No. 61/058,588, titled “STEALTHY DEBUGGER”, filed on Jun. 4, 2008, the disclosure of which is hereby incorporated by reference.

### TECHNICAL FIELD

The invention relates generally to software security and more particularly, to debugging and reverse engineering of software

### BACKGROUND

Dynamic analysis is a powerful tool for reverse engineering. However, malicious software, such as viruses, worms, Trojan horse programs, spyware, and other malware, may use anti-debugging or packing measures in order to make dynamic analysis more difficult. Anti-debugging increases the amount of time it takes for identifying, understanding malware algorithms, which may delay the time before a fix becomes available. Typical anti-debugging techniques attempt to detect debugging breakpoints, for example by searching for INT 3, or CC values, or the use of DR0-DR7 hardware registers. Some anti-debugging techniques attempt to determine whether a debugger has registered with the operating system (OS). Unfortunately, many debuggers are detectable using these techniques.

Traditional Ring-3 debuggers (GDB and IDA Pro) need to register with the OS to begin debugging a user application. They need to handle signals such as a SIGTRAP to handle an INT 3, and are easily detectable due to Linux debuggers needing to use ptrace( ) to debug a binary. Anti-debugging tricks commonly found in Linux malware include: ptrace( ); signal( ); checks for CC's (INT 3's); checks for hardware registers DR0-DR7; known debugger signatures; thrown exceptions; single-stepping checks; parent-child self-debugging; and reading/proc/self/stat.

### BRIEF DESCRIPTION OF THE DRAWINGS

For a more complete understanding of the present invention, reference is now made to the following descriptions taken in conjunction with the accompanying drawings, in which:

FIG. 1 illustrates a feature comparison table between an embodiment of a new debugger and prior art debuggers.

FIG. 2 illustrates source code for a test case.

FIG. 3 illustrates runtime output of the test program.

FIG. 4 illustrates an IDA Pro disassembly of the test program.

FIG. 5 illustrates a command window output during test program execution.

FIG. 6 illustrates the output of an embodiment of a stealthy debugger.

FIG. 7 illustrates an embodiment of a debugger driver.

FIG. 8 illustrates an IDA Pro disassembly of a test case.

FIG. 9 illustrates a transition between user mode and kernel mode.

FIG. 10 illustrates a notional hijacking of a system interrupt by the debugger.

FIG. 11 illustrates code for hooking an executing process.

FIG. 12 illustrates a hooked uname syscall.

FIG. 13 illustrates an execution flow for an embodiment of a debugger operating on a test program.

FIG. 14 illustrates output of an embodiment of a stealthy debugger.

FIG. 15 illustrates a mapping of the code to the debugger output.

FIG. 16 illustrates another mapping of the code to the debugger output.

FIG. 17 illustrates a method of stealthy debugging.

FIG. 18 illustrates an embodiment of a stealthy debugging system.

### DETAILED DESCRIPTION

The Linux operating system (OS) is not immune to malware and viruses. Protection against such malicious logic often requires reverse engineering binary executable files, which are laced with anti-debugging protections. This can be a tedious and time consuming process. Commercial, off-the-shelf (COTS) debuggers, such as GDB and IDA Pro, are detected in Linux utilizing a variety of anti-debugging techniques. Traditional Ring-3 debuggers (GDB and IDA Pro) need to register with the OS to begin debugging a user application. They need to handle signals such as a SIGTRAP to handle an INT 3, and are thus easily detectable, due to Linux debuggers needing to use ‘ptrace’ to debug a binary.

However, using the disclosed debugger, registration with the OS is not required. Checks for ptrace( ), signal( ), INT 3's, and hardware debug register use are circumvented. This is because a debugger for a system that uses interrupts to invoke kernel functionality, for example a debugger which leverages INT 80 interrupts that trigger Linux OS kernel functionality, can escape detection by many debugger detection methods. Unlike the INT 3, which is a flag for a debugger, INT 80's are an OS kernel interrupt for the Linux OS. Therefore INT 80's will be present in almost any Linux program, and attempting to detect a debugger through the presence of INT 80's is not practical, due to the excessive rate of false alarms.

An embodiment of the disclosed Helikaon Debugger™ is a stealthy Linux-driver-based debugger that will aid the engineer in debugging a running executable, such as malware and viruses. Embodiments inject a jump at runtime from kernel land into a user mode running process, rather than using standard debugger breakpoints like INT 3 or DR0-DR7 hardware registers. Using an embodiment of the debugger to inject jumps to reroute code at runtime allows the debugger to have command of a running executable at a particular address. Since the injections are dynamic, the code remains unmodified after its run is completed and injected jumps are removed immediately after they are used. It is thus able to debug even protected drivers.

The inventive concepts disclosed herein, however, are not limited to the Linux OS, but may also be used with other operating systems, including the Mac OS, the MicroSoft Windows OS, and other operating systems.

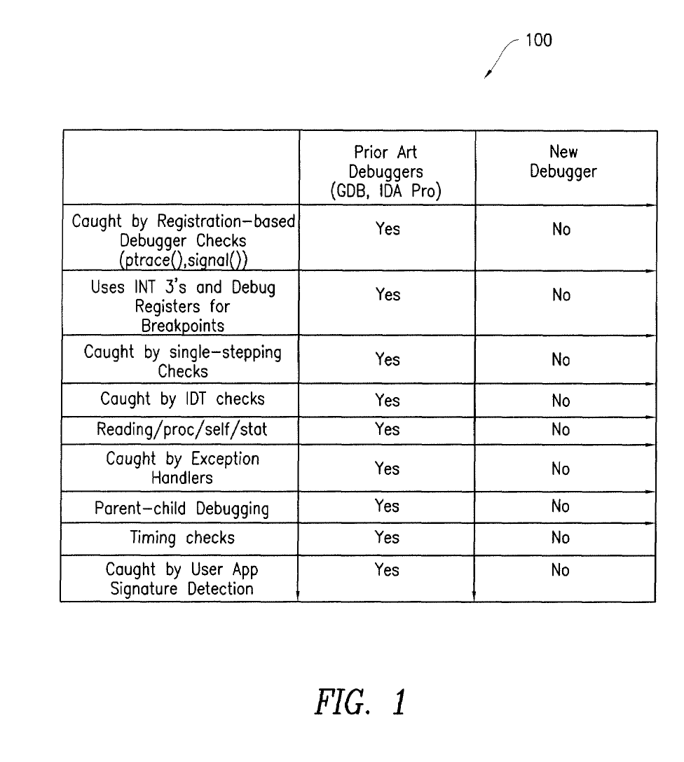

FIG. 1 illustrates a feature comparison table 100 between an embodiment of a new debugger and prior art debuggers. As can be seen from comparison table 100, embodiments of the new debugger offer numerous significant advantages over the prior art, which are a testament to its novelty and non-obviousness. The new debugger escapes detection by a myriad of techniques. Table 100 is a partial list of the failures by others to solve a long-felt need for a stealthy debugger.

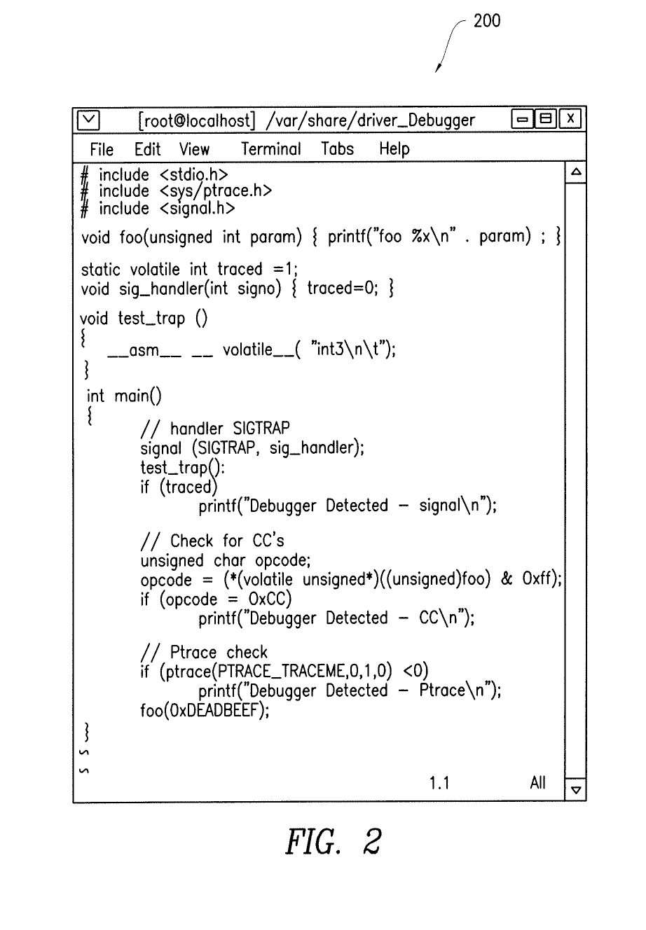

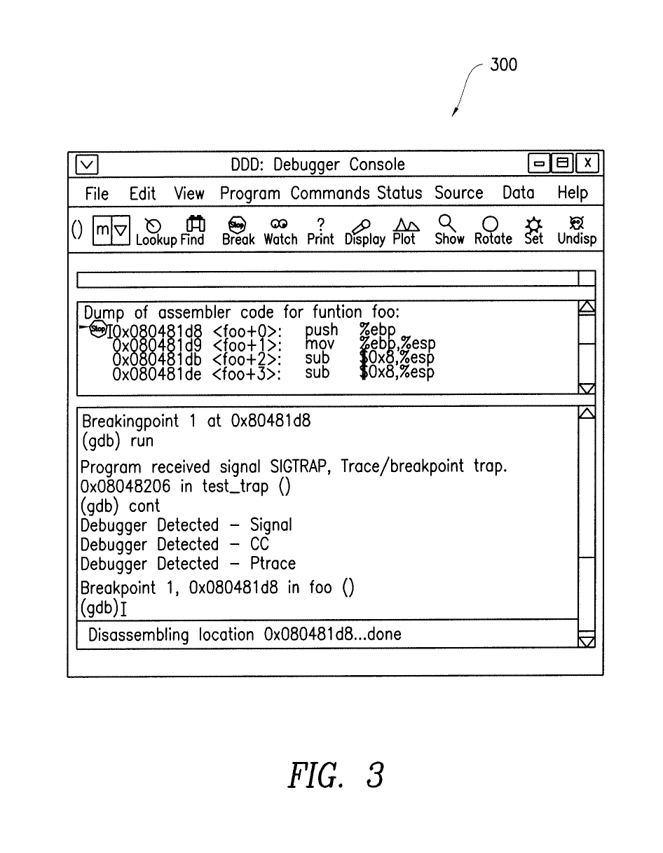

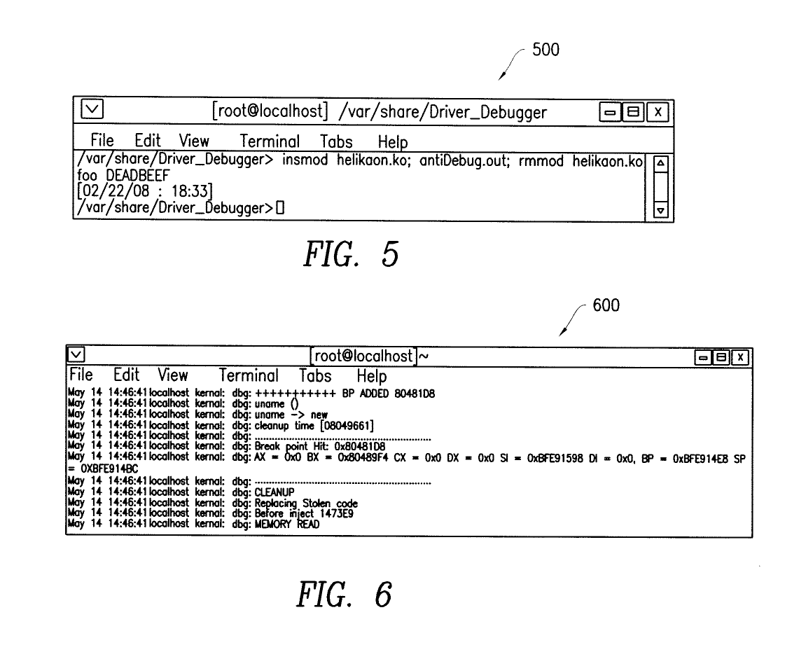

FIG. 2 illustrates source code for a test case 200, which will be used as an example debugging target program for explaining the subsequent figures, and to illustrate the use and capabilities of the new stealthy debugger. The source code includes debugging detection code “signal(SIGTRAP, sig_handler)”, “opcode==0xCC”, and “ptrace(PTRACE_TRACEME, 0, 1, 0)”. As a preview of the description of FIG. 5, note that the instruction “foo(0xDEADBEEF)” is after the debugger checks. FIG. 3 illustrates runtime output 300 of the test program of FIG. 2, in which the GDB debugger is detected. Note the GDB command “(gdb) run”, which results in detection of the GDB debugger, by all three detection methods illustrated in test case 200. Had test case 200 been actual malware, rather than a demonstration program, the retection of GDB would not have been reported, but instead, the malware would have performed some technique to either hide itself, damage the host computer, or attempt some other malicious task in response to identifying an attempt at reverse engineering.

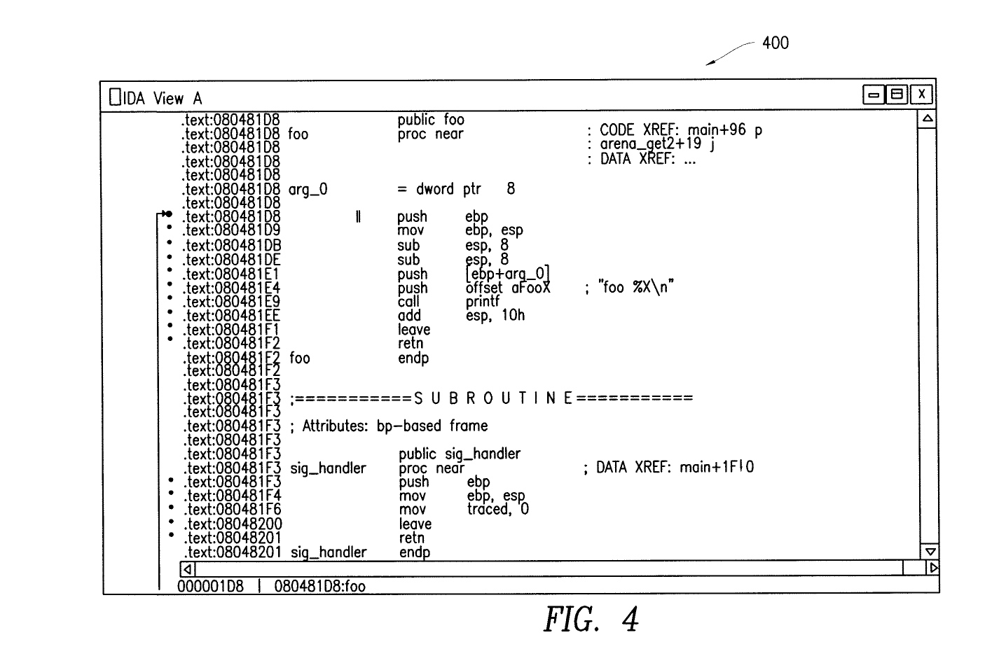

FIG. 4 illustrates an IDA Pro disassembly report 400 of the test program of test case 200. An embodiment of the new debugger will dynamically insert a breakpoint at 0x80481D8, illustrated as initially containing the instruction “push ebp” at line “text: 080481D8”. However, since the insertion of the emulated breakpoint will be dynamic, by injecting a jump instruction at runtime, the breakpoint does not exist statically and is therefore not visible in the report 400. The jump will also be removed dynamically, and replaced with the original “push ebp” instruction, so that the original instruction can be executed. The emulated breakpoint will also not be detectable by the standard methods described previously. For some embodiments, upon the program completing execution, and being deleted from memory, evidence of the debugger will be permanently erased, and no changes to the program will exist in permanent memory, which can be attributable to the stealthy debugger.

FIG. 5 illustrates a command window output 500 during test program execution of test case 200, under the control of the stealthy debugger. Recalling the description of FIG. 2, note that the instruction “foo(0xDEADBEEF)” has been reached, without triggering any of the debugger checks. As illustrated in FIG. 5, the stealthy debugger has escaped detection. FIG. 6 illustrates a command window output 600 of the embodiment of a stealthy debugger used with test case 200 as the target program for debugging. The target program execution state may be observed using the stealthy debugger. Dynamically injecting jumps to reroute execution of the target program allows embodiments of the debugger to have command of the executing target program. Breakpoints may even be inserted into packed code, because since the injection is dynamic, no changes to the executable file are needed for the packed file in permanent storage.

In FIG. 6, multiple register values displayed in command window 600. Registers are memory location, typically within a central processing unit (CPU). Other memory accessed by target program, such as heap memory and the stack, may also have the contents reported and be modified as part of the debugging operations. Other steps performed by the stealthy debugger process are also indicated in FIG. 6. Some of the operational steps include that a pointer to a system function is replaced with a pointer to a first debugger module, having dynamic jump insertion functionality. A second debugger module, having the desired debugging functionality, is placed into slack space of a target program, or another memory location accessible by the target program. Slack space is a portion of memory accessible to an executable program that does not contain instructions or data that will be needed for later execution. Sections of a program that are left filled with NOP instructions during compilation process are often described as slack space, although other memory locations also may be described as slack space, including executable instructions that will not be executed again, such as bootloader space. Embodiments of a general debugger module may comprise the functionality of both the first and second debugger modules.

The code for dynamically injecting a jump comprises code for copying memory contents of the target program from a selected breakpoint location at a first memory location in the target program to a second memory location, for example slack space of the target program. The code for dynamically injecting a jump may further include code for writing a jump instruction that will cause the execution point from the selected breakpoint to jump the second debugger module. After performing the debugging operation on the target program, at the selected breakpoint location, the jump to the second debugger module may be dynamically removed. This can be performed by replacing the memory contents that were in the first memory location, and which had been over-written by the dynamically inserted jump, and then returning execution to that location. To accomplish this, embodiments of the stealthy debugger may copy the memory contents to the first memory location from the second memory location.

Note in FIG. 6 the debugger status reports indicating “uname( )” has been reached; “Break Point Hit” at the memory location 080481D8, identified in the description of FIG. 4 as the selected breakpoint location; and “Replacing Stolen Code”. The system call uname( ) has been hooked to use for dynamically inserting a jump at 080481D8, which provided the debugger functionality that enables reporting the register contents. The status report “Replacing Stolen Code” indicates that the dynamically inserted jump has been dynamically removed.

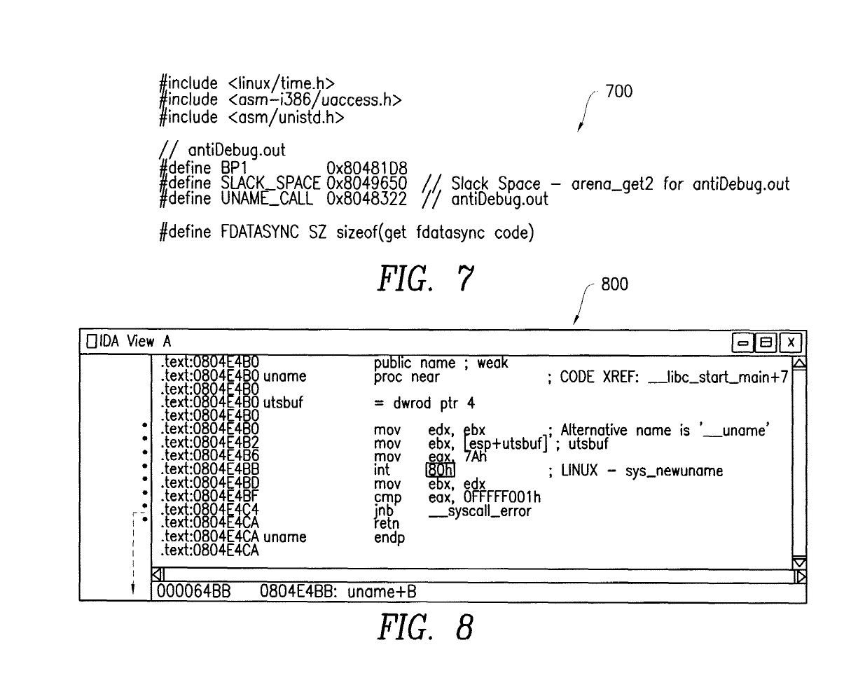

FIG. 7 illustrates an embodiment of a debugger driver in code listing 700. A debugger driver can use three pieces of information before being compiled and loaded: a selected breakpoint location (memory address); a slack space address, which could be bootloader space; and a return address of a syscall function, here shown as uname( ), to hook for the dynamic jump insertion. The syscall function could be one that executes early, for example uname( ) executes in bootloader code. This ensures that the jump is inserted prior to the emulated breakpoint location being reached during execution.

FIG. 8 illustrates an IDA Pro disassembly window 800 of the example test case, in which the Linux kernel interrupt instruction, “int 80h”, is shown at address 0804E4BB. The comment on that disassembly line is “LINUX-sys_newuname” which indicates a syscall function. The address of the function will be in a syscall table, which the CPU will reference to identify the location of the instructions to execute as the function call. This provides an opportunity for the debugger. By replacing the pointer to a system function, such as uname( ), in the syscall table, execution can be rerouted to the first debugger module, which dynamically injects the emulated breakpoint jump. The call to the real system function can then be executed afterward. The specific mechanism used in the Linux OS, to permit the redirection of a system function, is that following an INT 80 interrupt, the Linux kernel looks at the contents of the EAX register to determine the address of the system call to be accessed. The Linux kernel assumes that the proper system function address was placed in EAX, after being provided by the syscall table. Thus violating the assumption, by placing a different function's address in the syscall table permits redirection and thus, stealthy debugging.

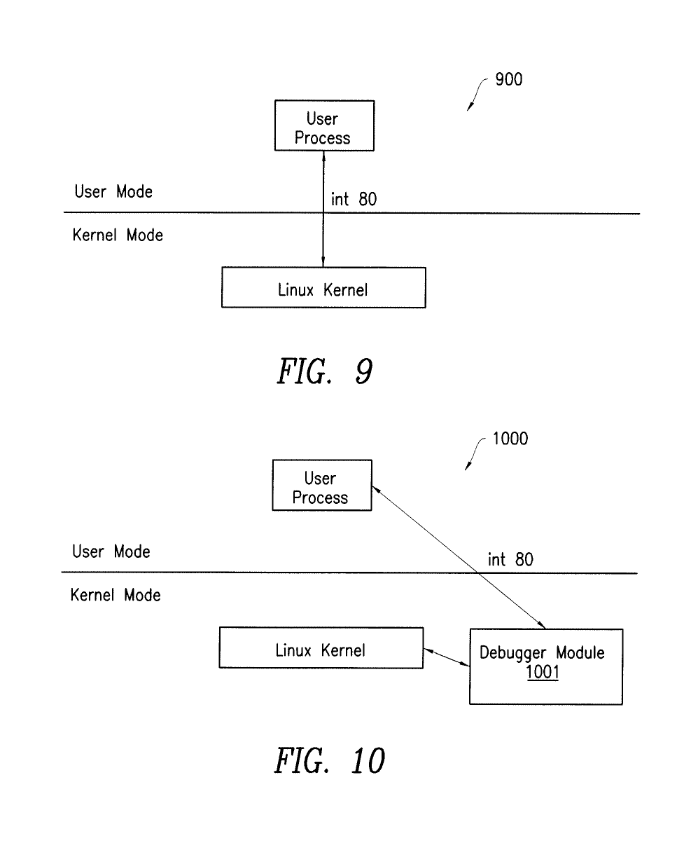

FIG. 9 illustrates a transition diagram 900 between user mode and Linux kernel mode. As illustrated in FIG. 9, the INT 80 interrupt of FIG. 8 causes a transition from user mode to kernel mode. Upon completion of the system function, execution returns to the user process in user mode. FIG. 10 illustrates a notional hijacking of a system interrupt by the debugger, as previously described, in a transition diagram 1000. The INT 80 interrupt causes a switch to kernel mode, but instead of going directly to the system function, execution moves first to a debugger module 1001. Debugger module 1001 can then dynamically inject a jump to a second debugger, which contains debugging functionality, such as reporting and modifying the contents of memory accessed by a target user process, and either may or may not be part of the same module as the first debugger module. Therefore, INT 80 interrupts, which are relied upon by the Linux OS, can be exploited to enable debugging in a manner that is difficult for malware to detect or defeat.

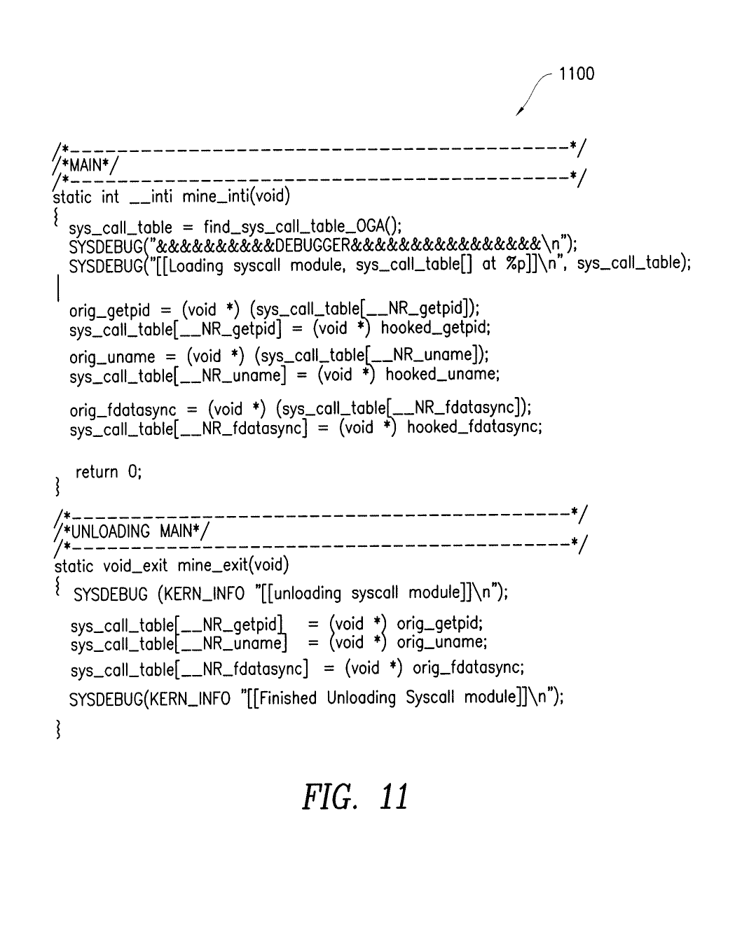

FIG. 11 illustrates a code listing 1100 for hooking an executing process, in which three pointers to system function in the syscall table are replace with pointers to modules having debugger functionality, such as code for dynamically injecting jumps to other debugger modules. In “_init mine_init( )” of FIG. 11, the instruction “sys_call_table[_NR_getpid]=(void*) hooked_get_pid;” replaces the pointer (void type) of the system function get_pid( ), which gets process identifiers, with a hooked system call that enables functionality for an embodiment of the stealthy debugger. Prior to the replacement in the syscall table, however, the original address is saved, using the instruction “orig_getpid=(void*) (sys_call_table[_NRgetpid]);”, so that it can be restored later, using “sys_call_table[_NRgetpid])=(void*) orig_getpid;” in “_exit mine_init( )”. System functions uname(0 and fdatasync( ) are similarly hooked to facilitate debugging functionality.

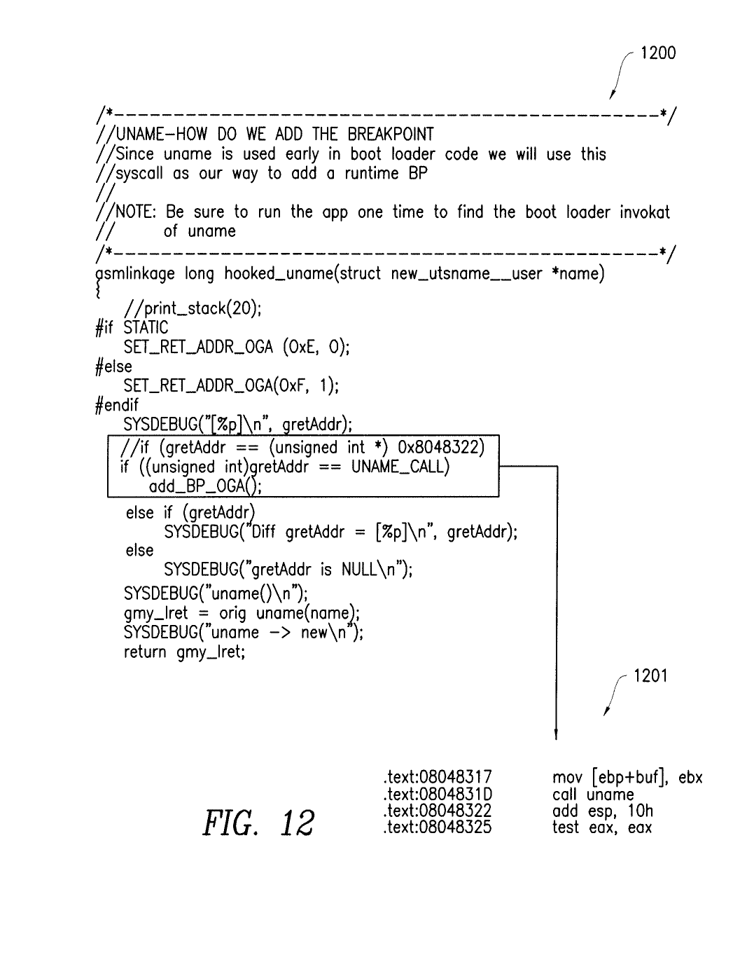

FIG. 12 illustrates, in code listing 1200, a hooked uname( ) syscall, that could be executed as a result of the “sys_call_table[_NR_uname]=(void*) hooked_uname;” instruction in “_init mine_init( )” of FIG. 11. In the illustration, address 0848322 is the location of the desired breakpoint, which is put into the uname( ) code that is called by the Linux kernel. As described previously, the table referenced by the kernel, for example a syscall table referenced by the Linux kernel, is modified such that the kernel jumps to the illustrated version of uname( ). The illustrated version of uname( ) emulates a breakpoint using a jump, and then calls the original uname( ) (not illustrated). Code listing 1200 is annotated with a corresponding IDA Pro disassembly listing 1201. Code listing 1200 is in the C++ programming language, whereas IDA Pro disassembly listing 1201 is in Assembly language.

The stealthy debugging process requires tasks to be performed by different modules. Debugger module 1: Hook syscalls uname( ) and fdatasync( ). These are used as examples. Different syscalls could be used. User process: syscall uname( ) is executed in bootloader code. Debugger module 2: Hooked syscall uname( ) is rerouted to driver, as illustrated in FIG. 12 The bytes replaced at the selected location of the breakpoint by the dynamically inserted jump, called “stolen bytes”, are saved. For some embodiments, this will be 5 bytes, since the dynamically injected jump may occupy 5 bytes. From the hooked syscall, dynamically inject a “JMP” (jump instruction) to debugger module 3, possibly located in the target program's slack space. The debugger module 3, containing breakpoint handler code having debugging functionality, is inserted into the slack space at the location indicated by the inserted jump instruction.

When the breakpoint is encountered, in the user process, the instruction pointer EIP will indicate the “JMP” and control will pass to debugger module 3 handler code. The handler code pushes the register contents onto the stack and triggers an interrupt. This generates a call to syscall fdatasync( ), which has already been hooked, as indicated in FIG. 11. Hooked fdatasync( ): The register contents are reported by printing to the screen in a command window. Other debugging functionality could also be executed, including modifying memory contents. The stolen bytes in the user process are replaced, which amounts to dynamically removing the inserted jump. Control is returned to the user process. In the debugger module in the user process slack space: Pop all registers that had been pushed onto the stack. Jump back to the breakpoint, which now contains the restored stolen bytes. Execution of the target program continues.

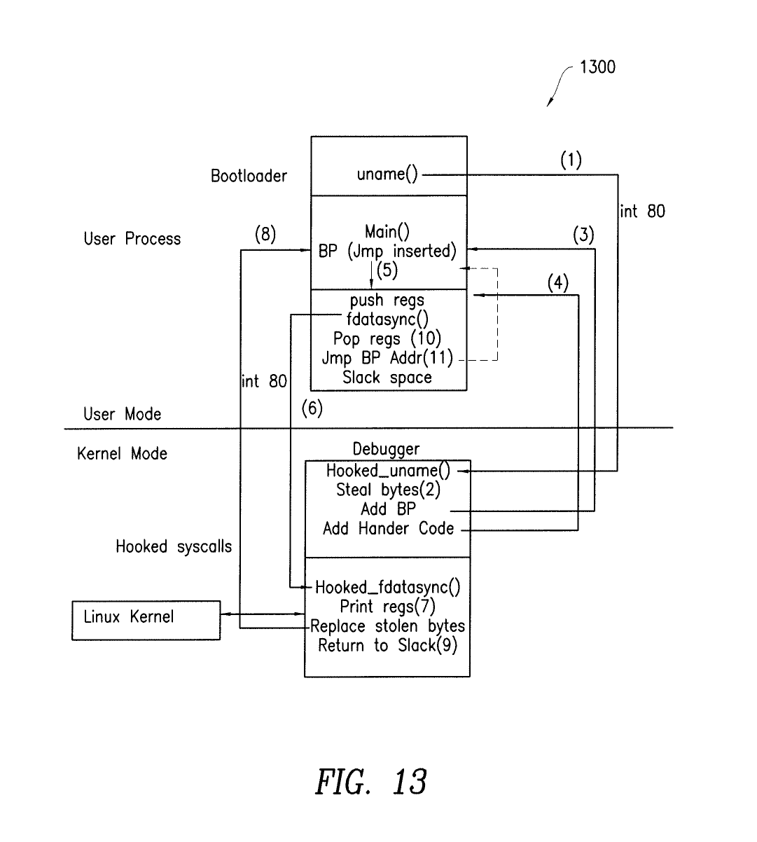

FIG. 13 illustrates an execution flow diagram 1300 for an embodiment of a debugger operating on a target program. (1): The bootloader calls uname( ), employing an INT 80 interrupt. (2) The hooked uname( ), as illustrated in FIG. 12, copies the required number of bytes, for example 5 in some embodiments, to a safe location. For current version of the Linux OS, 5 bytes is enough to insert a jump command, in to the main( ) process, although a greater number of bytes may also be saved and later versions of the Linux OS may require more than 5 bytes for injecting a jump command. (3) A breakpoint is inserted by replacing the bytes with a jump instruction (“JMP”). This is identified in diagram 1300 as “Steal bytes”. (4) Handler code, for example instructions to push the registers onto the stack, a call to fdatasync( ), and instructions to restore the registers from the stack, and/or other debugging functionality, is inserted into slack space. (5) Execution returns to the program, which enters main( ) and hits the inserted jump where the bytes had been replaced. (6) The registers are pushed onto the stack, and the hooked fdatasync( ) is called, by using an INT 80 interrupt. (7) Debugging functionality, inserted into the hooked fdatasync( ) is executed, for example printing the register contents, illustrated as “Print regs”. The register contents may be printed from and changed using the values on the stack, since they had been pushed to the stack prior to the jump, and will be restored afterward. Other debugging functionality may also be used, such as modifying the registers (on the stack) and/or modifying or reporting other sections of memory. (8) The bytes that had been replaced by the JMP are replaced. (9) Execution is returned to the slack space, where the registers are popped back from the stack (10). Any changes to the stack contents are now reflected in the registers. In this manner, the registers may be changed by changing the stack contents between the push and pop commands. (11) The program then jumps back to the newly restored bytes.

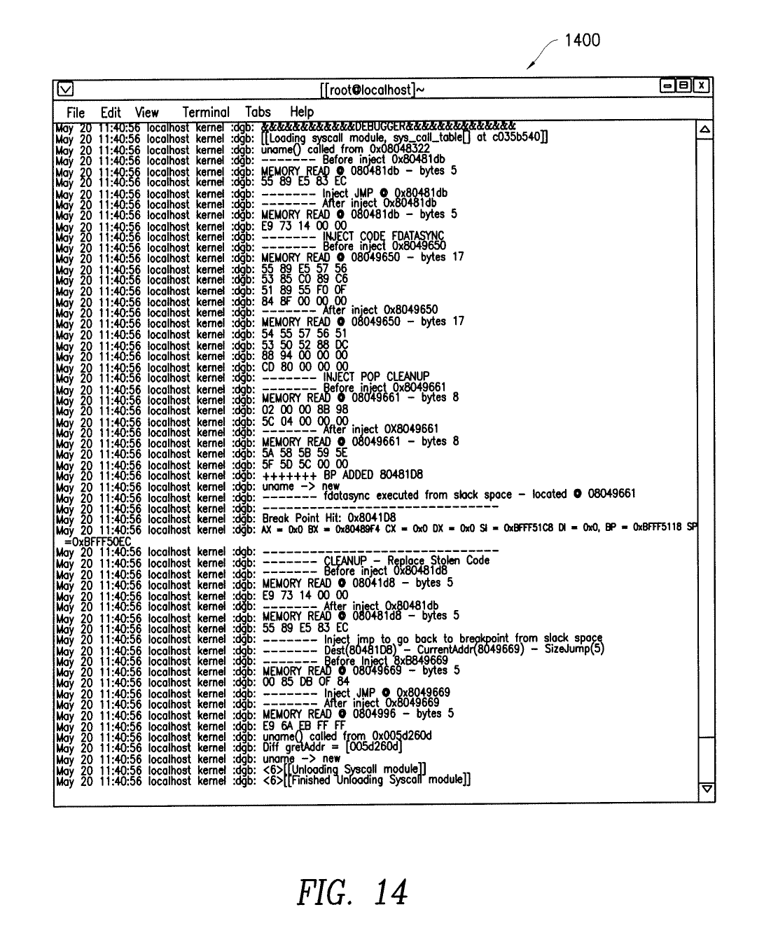

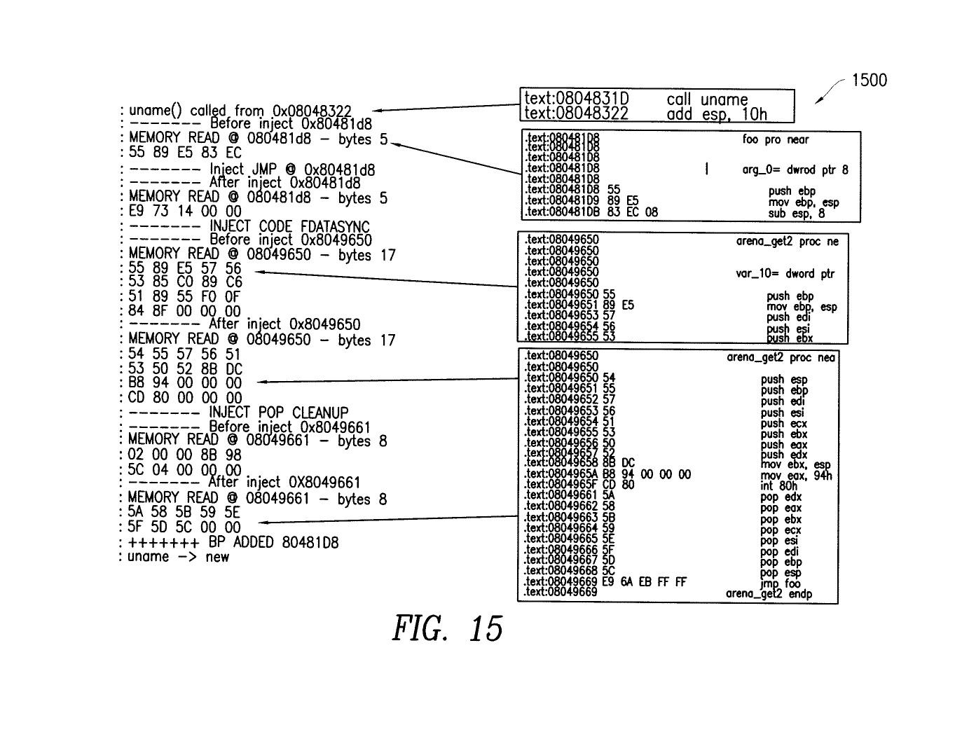

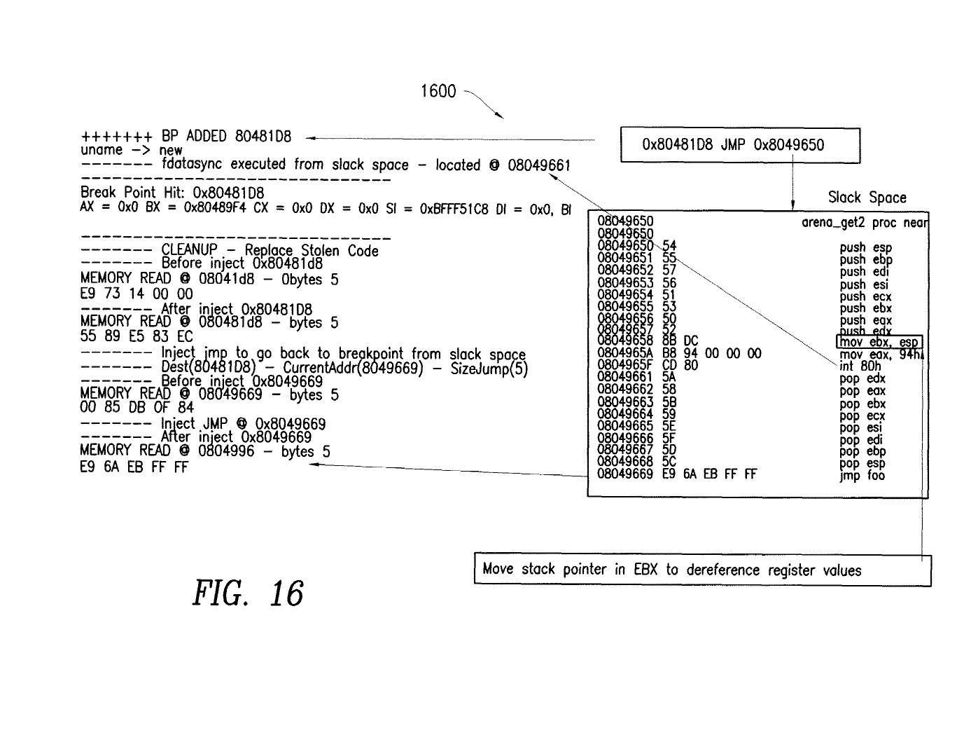

FIG. 14 illustrates a command window output 1400 for an embodiment of a stealthy debugger. Some of the stages indicated in FIG. 13 are shown in the output listing, for example calling uname( ), injecting a JMP, injecting the POP register cleanup, adding a breakpoint at the target address, and replacing the stolen bytes. FIGS. 15 and 16 illustrate a mapping of the code to the debugger output, for example, the call to uname( ) and the code for pushing and popping the registers. The INT 80 interrupt is also illustrated in the disassembly listing. As illustrated, the stack pointer in ESP is moved to EBX. The fdatasync( ) syscall takes an integer argument and returns a value (typically 4 bytes) using the EBX register, so this register may be used for passing a value to and from the hooked fdatasync( ). By passing the stack pointer into the hooked fdatasync( ), the locations of the register values copied onto the stack may be found. This enables examination and manipulation of the register contents, as copied onto the stack, and will be copied back from the stack at a later time, within the hooked fdatasync( ).

Even encrypted code that becomes decrypted in memory makes a system call, so the inventive stealthy debugger can be used with encrypted code. The debugger may be looped by iteratively replacing stolen bytes in slack space and then jumping to the next set of bytes, for example using JMP [bpAddr+5], JMP [bpAddr+10] . . . , where bpAddr is the original breakpoint address. Instruction tracing can be accomplished by rerouting every instruction with the JMPs. Software, which attempts to prevent reverse engineering by dynamic analysis through means of anti-debugging measures, can now be analyzed using an embodiment of the stealthy debugger that thwarts the anti-debugging measures. Some embodiments of a stealthy debugger exploit the INT 80 interrupt. Instructions in other drivers may also be rerouted. For some embodiments, a graphical user interface (GUI) may be employed for a user interface, to simply debugging tasks. Shared memory may also be used in place of slack space, and slack space may be cleaned up by a number of different methods.

Using the new debugger, registration with the OS is not required. Checks for ptrace, signal, INT 3's, and hardware debug register use are circumvented. The new debugger injects jumps to reroute code, allowing the debugger to have command of the running executable at a particular address. Since the driver's injections are dynamic, the code remains unmodified after its run is completed and injected jumps may be removed after they are used.

Embodiments of the driver uses certain information, which may be inserted prior to compilation and loading: breakpoint address; slack space address; and a return address of a syscall such as uname( ). These addresses may be added to the driver as #defines. Then, the code is recompiled and the debugger driver is loaded. The return address of the syscall should be a syscall that executes early, say in bootloader code, like the syscall to uname( ). However, a different syscall can be used. One consideration is to select one that occurs prior to EIP hitting the desired breakpoint location. The second hooked syscall can be any syscall, but one that takes an unsigned integer as a parameter is preferable. A sample disassembly of a program that calls fdatasync( ) is: MOV EBX, [ESP+fd]; MOV EAX, 94h; INT 80h.

When copying the second interrupt, for example for fdatasync( ), to the slack space, the following example pseudo-code may be used: PUSH registers; MOV EBX, ESP; MOV EAX, 0x94; INT 80h.

When the hooked fdatasync( ) is invoked at the user process, it will use the parameter stored in EBX, which is the pointer to the stack in user space, to identify the location of the copied register data. The register values can be examined, printed, modified, or used in other ways. An example of a breakpoint hit using the debugger is given by:

Feb 22 13:31:03 localhost kernel: dbg: +++++++++++ BP ADDED
80482A0
Feb 22 13:31:03 localhost kernel: dbg: uname( )
Feb 22 13:31:03 localhost kernel: dbg: uname -> new
Feb 22 13:31:57 localhost kernel: dbg: cleanup time [08049681]
Feb 22 13:31:57 localhost kernel: dbg: --------------------------------
Feb 22 13:31:57 localhost kernel: dbg: Break Point Hit: 0x80482A0
Feb 22 13:31:57 localhost kernel: dbg: AX = 0xFFFFFFFF
BX = 0x8048A18 CX = 0x0 DX = 0x1B SI = 0xBFEF3558 DI = 0x0,
BP = 0xBFEF34A8 SP = 0xBFEF3490
Feb 22 13:31:57 localhost kernel: dbg: --------------------------------
Feb 22 13:31:57 localhost kernel: dbg: CLEANUP
Feb 22 13:31:57 localhost kernel: dbg: Replacing stolen code

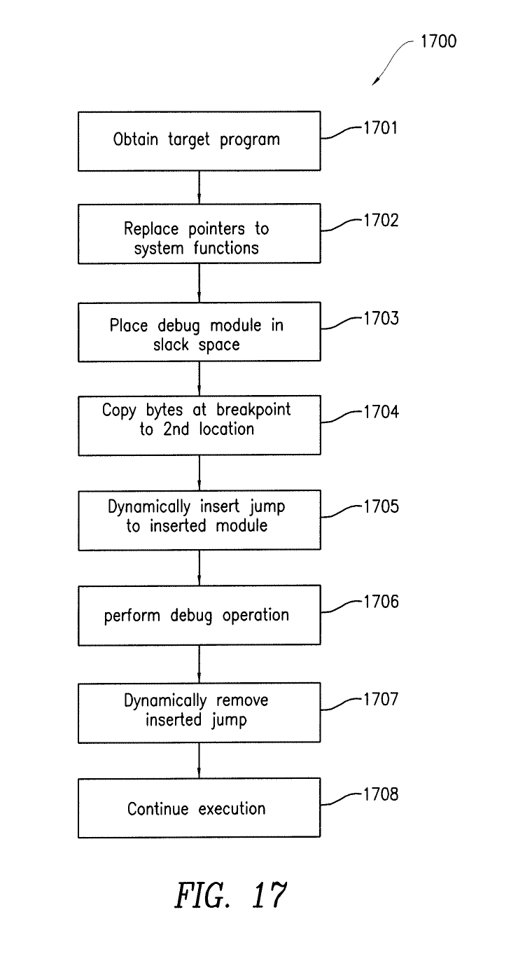

FIG. 17 illustrates a method 1700 of stealthy debugging. Method 1700 is an alternative description of the description given for execution flow diagram 1300 of FIG. 13. In the following description, some of the processes are in a different order than in the description of execution flow diagram 1300. This reflects the possibility for some of the processes to be performed in varying order.

In box 1701, a target program is obtained for debugging, and in box 1702, pointers to system functions are replaced with pointers to hooked functions, which act as debugger modules. Replacing a pointer to a system function may comprise replacing a pointer to a system function in a syscall table. In box 1703, handler code, acting as another debugger module is placed in a slack space of the target program. In boxes 1704 and 1705, a jump is dynamically injected into the running target program. Specifically, in box 1704, a set of bytes that will be over-written with the jump instruction and jump location are copied from their original position at a selected breakpoint location (first memory location) to a second memory location. Then, in box 1705, the jump instruction and jump location are written over the instructions just saved from the first memory location. A debugging operation is performed on the target program in box 1706. The inserted jump is dynamically removed in box 1707. This may comprise copying the memory contents from the second memory location back to the first memory location. Execution of the target program is resumed in box 1708.

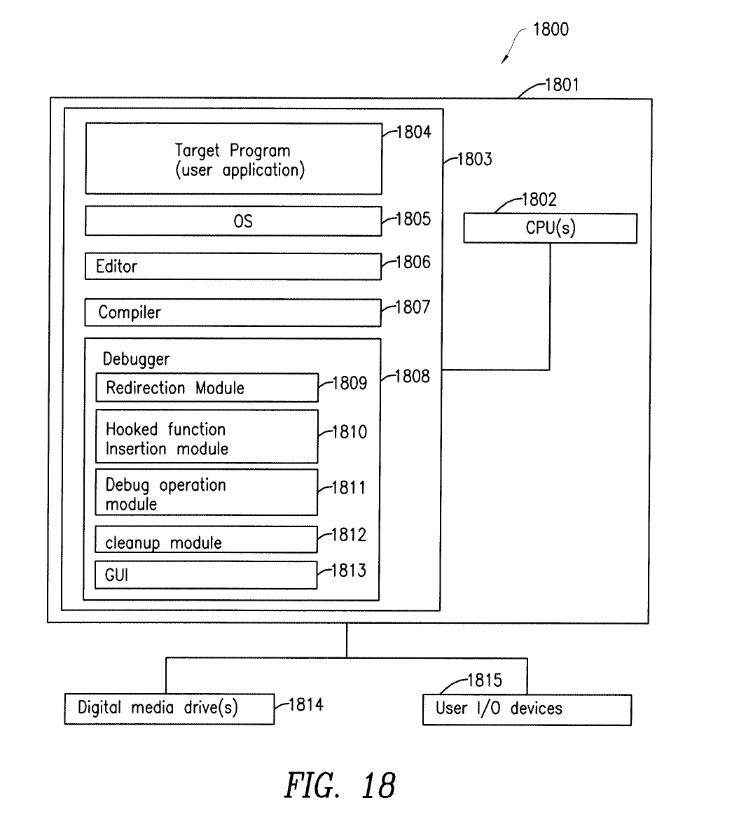

FIG. 18 illustrates an embodiment of a stealthy debugging system 1800. System 1800 comprises computing apparatus 1801, which comprises at least one CPU 1802, and a memory 1803. Memory 1803 comprise a combination of volatile memory, non-volatile memory, random access memory (RAM), read only memory (ROM), magnetic storage media, optical storage media, or any other computer readable medium. Target program 1804 is executable by a processor, for example CPU(s) 1802, and is within memory 1804, along with OS 1805. An editor 1806 and compiler 1807 may also be provided to enable editing and compiling of debugger modules, in support of the procedures described previously. Debugger 1808 comprises a number of modules and is configured to operate as described in the previous figures. The debugger modules include a redirection module 1809, an example of which was described in code listing 1100. Another module is an insertion module 1810, an example of which was described in code listing 1200. Another module is a debugging operation module 1811, an example output of which was illustrated in command window 600. Another module is cleanup module 1812, which removes the jump inserted by module 1810, and may pop register contents from the stack. The operations of modules 1811 and 1812 may be combined in some embodiments. A GUI module 1813 may be included in some embodiments. The debugger modules may comprise code that is executable by a processor.

The methods disclosed herein may be performed using a computer program embodied on a computer readable medium, for example, an optical medium, a magnetic medium, or non-volatile memory. Such software may be executable by a processor. Further, hardware apparatus, for example, an application specific integrated circuit (ASIC) and/or a field programmable gate array (FPGA) may be utilized. It should also be understood that, as further advances are made in computer-related technology, the invention may take advantage of such advances.

Although the present invention and its advantages have been described, it should be understood that various changes, substitutions and alterations can be made herein without departing from the spirit and scope of the invention as defined by the appended claims. Moreover, the scope of the present application is not intended to be limited to the particular embodiments of the process, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of debugging software, the method comprising:
dynamically injecting a jump into an executing target program;
performing a debugging operation on the target program; and
dynamically removing the injected jump from the target program, wherein the target program is embodied on a computer readable medium and executable by a processor.

2. The method of claim 1 wherein dynamically injecting a jump comprises:
copying memory contents of the target program from a selected breakpoint location at a first memory location to a second memory location; and
writing a jump instruction and jump location to the first memory location;
and wherein dynamically removing the injected jump comprises:
copying memory contents to the first memory location from the second memory location.

3. The method of claim 2 wherein copying memory contents comprises copying five bytes.

4. The method of claim 1 wherein performing a debugging operation comprises performing an operation selected from the list consisting of:
modifying contents of memory accessed by the target program, and
reporting contents of memory accessed by the target program.

5. The method of claim 1 wherein modifying contents of memory used by the program comprises modifying a register.

6. The method of claim 1 further comprising:
replacing a pointer to a system function with a pointer to a debugger module.

7. The method of claim 6 wherein replacing a pointer to a system function comprises replacing a pointer to a system function in a syscall table.

8. The method of claim 6 further comprising:
placing the debug module in a slack space of the target program.

9. A debugger program, embodied on a computer readable medium and executable by a processor, the debugger program comprising:
code for dynamically injecting a jump into an executing target program;
code for performing debugging operations on the target program; and
code for dynamically removing the injected jump from the target program, wherein the target program is embodied on a computer readable medium and executable by a processor.

10. The debugger program of claim 9 wherein the code for dynamically injecting a jump comprises:
code for copying memory contents of the target program from a selected breakpoint location at a first memory location to a second memory location; and
code for writing a jump instruction and jump location to the first memory location;
and wherein the code for dynamically removing the injected jump comprises:
code for copying memory contents to the first memory location from the second memory location.

11. The debugger program of claim 9 wherein the code for performing a debugging operation comprises code for reporting contents of memory accessed by the target program.

12. The debugger program of claim 9 further comprising:
code for replacing a pointer to a system function with a pointer to a debugger module.

13. The debugger program of claim 9 further comprising:
code for placing the debugger module in a slack space of the target program.

14. A debugging system comprising:
a processor;
memory coupled to the processor; and
a debugger module configured to:
dynamically inject a jump into a target program;
performing a debugging operation on the target program; and
dynamically removing the injected jump from the target program.

15. The system of claim 14 wherein the debugging module comprises circuitry in an integrated circuit selected from the list consisting of:
a field programmable gate array (FPGA), and
an application specific integrated circuit (ASIC).

16. The system of claim 14 further comprising a target program embodied on a computer readable medium and executable by a processor.

17. The system of claim 14 wherein the debugging module is configured to:
copy memory contents of the target program from a selected breakpoint location at a first memory location to a second memory location;
write a jump instruction and jump location to the first memory location; and
after performing the debugging operation on the target program, copy memory contents to the first memory location from the second memory location.

18. The system of claim 14 wherein the debugger module is configured to report contents of memory accessed by the program.

19. The system of claim 14 wherein the debugger module is configured to replace a pointer to a system function with a pointer to a portion of the debugger module.

20. The system of claim 14 wherein the debugger module is configured to place a portion of the debugger module in a slack space of the target program.
